(19) United States
(12) Patent Application Publication
(10) Pub. No.: US 2007/0096796 A1
(43) Pub. Date: May 3, 2007

(54) High voltage charge pump with wide range of supply voltage

(76) Inventors: Teezar R. Firmansyah, Singapore (SG); Gek Y. Ng, Singapore (SG)

Correspondence Address: DICKSTEIN SHAPIRO LLP, 1825 EYE STREET NW, Washington, DC, 20006-5403, US

(21) Appl. No.: 11/509,695

(22) Filed: Aug. 25, 2006

(30) Foreign Application Priority Data
Aug. 26, 2005 (SG) 200505297-2

(51) Int. Cl. G05F 1/10

(52) U.S. Cl. 327/536

(57) ABSTRACT

A charge pump circuit utilising CMOS or MOSFET (p-channel or n-channel) configured as switches for charge transfer is proposed. Instead of using the conventional diode-connected transistors, CMOS transistors configured as switches are used so that the threshold voltage drop across the stages of the charge pump is eliminated. Two of these charge pump chains are cross-coupled to bias each other at every stage. Consequently, the charge pump presented achieves higher voltage output efficiency with a wider supply voltage range.

### FIELD OF THE INVENTION

The present invention relates to electronic devices used as charge pumps, and specifically high voltage charge pumps. In particular, it relates to architectures for a charge pump circuit to give higher output voltage than its input.

### BACKGROUND OF THE INVENTION

Normally, high voltage charge pumps are circuits that pump electric charges into capacitors for generating a positive or negative output voltage higher than the supply. High voltage charge pumps are commonly used for providing high voltages to programme/erase programmable ROM (Read Only Memory) elements, such as EEPROM (Electrically Erasable and Programmable Read Only Memory), flash memory, power solid-state particles detectors and photo-multipliers, drive analogue switches, etc. Conventional charge pump circuits include a number of serially connected charge transfer stages and they are driven by clock signals. Every charge transfer stage comprises a diode (or transistor configured as a diode) and a capacitor. Multiple charge pumps can be further connected serially so that the output voltage can be increased more.

In recent years, there is a trend to progressively scale down the supply voltage for lowering down the power consumption of electronic devices. However, the programming/erasing voltage for EEPROM or other types of ROM in memory applications largely remain unchanged due to their process requirements. Hence, there is a need for a charge pump circuit that is more efficient in charge transfer at lower supply voltages.

A charge pump circuit of the prior art is disclosed in On-chip high-voltaqe generation in MNOS integrated circuits using an improved voltage multiplier technique, J. F. Dickson IEEE J. Solid-State Circuits, vol. SC-11, pp. 374-378, June 1976, the contents of which are incorporated herein by reference. An example of such a circuit is shown in FIG. 1. The circuit includes a number of stages where each stage contains a diode-connected transistor and a capacitor for charge transfer. In FIG. 1, Vin represents power input at lower voltage to the charge pump circuit while Vout represents the high voltage output of the charge pump circuit. The clock voltage signals are represented by φ_{A} and φ_{B} respectively and they are non-overlapping which means that they take turns to give HIGH or LOW voltage output at all times. This non-overlapping type of voltage inputs supplied to the charge pump circuit of FIG. 1 causes the voltage output to increase at every stage, which is often termed as the charge pumping action. Neglecting parasitic capacitance and output current load, the output voltage of this charge pump therefore becomes
Vout=Total Voltage Gain−Total Voltage Threshold Drop
which can also be expressed as
Vout=N*Vin−N*Vtm (1)

Here, N is the number of charge transfer stages including the output stage which is not a gain stage, and Vtm is the threshold voltage of a transistor modified by the body effect. The value of Vtm increases as the number of stages increases. Consequently, the total voltage output of the charge pump Vout equals to the difference between total voltage gain (N*Vin) and total voltage threshold drop (N*Vtm). In another word, the total voltage output of the charge pump is not directly proportional to the number of stages implemented and the efficiency of the charge pump is therefore reduced by the existence of total voltage threshold drop, which is caused by the diode drop at every stage. Extra stages are required due to low efficiency of the circuit and an output voltage of at least one Vtm higher than the desired output voltage must be developed. Furthermore, this circuit does not work well at low supply voltage levels.

To improve the charge pump efficiency, many attempts have been made. One such attempt is disclosed in MOS charge pump for low-voltage operation J. T. Wu and K. L. Chang IEEE J. Solid-State Circuits, vol. 33, pp. 592-597, April 1998, the contents of which are incorporated herein by reference. In this disclosure, the backward control scheme attempts to reduce the threshold voltage drop by adding the charge transfer switch circuit. However, it suffers a major loss in the output stage whereby the output voltage is at least one threshold drop from the desired value. This means that high breakdown transistors are required which limit the flexibility of its application. The complexity of the circuit adds unnecessary parasitic capacitance which degrades the charge pump efficiency. The circuit utilises NMOS transistors which are known to exhibit snap-back effect or avalanche-induced breakdown if short channel length is used. To overcome this problem, long channel length must be used which contributes to a larger area and worsen the efficiency due to increased parasitic capacitance.

A further example is disclosed in A new charge pump without degradation in threshold voltage due to body effect J. Shin, I. Y. Chung, Y. J. Park, and H. S. Min IEEE J. Solid-State Circuits, vol. 35, pp. 1227-1230, August 2000, the contents of which are incorporated herein by reference. This example is illustrated in FIG. 2. This circuit implements a different approach in that the threshold voltage increase due to body effect is controlled by active biasing of the body terminal. However, since the charge transfer devices are diode-connected transistors, this circuit cannot eradicate the major source of losses as one threshold voltage drop is lost per stage. This not only degrades the efficiency, it also makes the circuit unsuitable for low supply voltage application.

Common problems encountered by circuits that seek to improve upon that of Wu & Chang include the potential for latch-up, which occurs when the body of the charge transfer transistor is not biased properly and causes the diffusion-to-well diode to turn on.

### SUMMARY OF THE INVENTION

An object of the present invention is to provide a charge pump which overcomes at least some of the problems of the prior art.

Therefore, in the first aspect, the invention provides a charge transfer unit for generating an output voltage in response to an input voltage, a first unit signal, and a second unit signal, such that the output voltage has a greater magnitude than the input voltage; said charge transfer unit comprising:

a first, a second and a third CMOS transistors and a capacitor;

an input terminal, in communication with sources of the first and second transistors and a gate of the third transistor, said input terminal connected to the input voltage;

a signal terminal, in communication with gates of the first and second transistors, said signal terminal connected to the first unit signal;

an output terminal, in communication with drains of the first and third transistors and a first terminal of the capacitor, said output terminal connected to the output voltage;

a clock terminal, in communication with second terminal of the capacitor, said clock terminal connected to the second unit signal, and;

bulks of the three CMOS transistors connected to the drain of the second CMOS transistor and the source of the third CMOS transistor; wherein the CMOS transistors are configured as switches.

In the second aspect, the invention provides a charge transfer input stage for generating an output voltage in response to at least one input voltage, a first stage signal and a second stage signal; said charge transfer input stage comprising two charge transfer units according to claim 1, wherein

the clock and signal terminals of the first charge transfer unit are connected to the first stage signal, and;

the clock and signal terminals of the second charge transfer unit are connected to the second stage signal, wherein

the input terminals of each unit are connected to either different or the same input voltage.

In the third aspect, the invention provides a charge transfer stage for generating an output voltage in response to two input voltages, a first stage signal and a second stage signal, said charge transfer stage comprising two charge transfer units according to claim 1, wherein

the clock terminal of the first unit is connected to the first signal;

the clock terminal of the second unit is connected to the second signal;

the input terminals are connected to different input voltages;

the signal terminal of the first unit is connected to the input terminal of the second unit, and

the signal terminal of the second unit is connected to the input terminal of the first unit.

In the fourth aspect, the invention provides a charge transfer chain for generating an output voltage in response to

an input voltage, a first chain signal, a second chain signal and a plurality of clock signals, such that the output voltage has a greater magnitude than the input voltage, said charge transfer chain comprising

a plurality of serially connected charge transfer units according to claim 1, such that:

the input terminal of the first unit is connected to the input voltage and the input terminal of subsequent units are connected to the output terminal of its preceding unit;

the signal terminal of the first unit is connected to the first signal; the clock terminals of the odd numbered units starting from the first unit are connected to the first signal;

the clock terminals of the even numbered units starting from the second unit are connected to the second signal;

the clock terminal of the last unit is connected to a voltage potential, such as ground;

the signal terminals of the even numbered units starting from the second unit are connected to clock signals which have the same phase as the second signal with a HIGH level of the clock signal voltages starting from at least two times the amplitude of the first and second signal; and thereafter the HIGH level of the clock signal increasing progressively along the chain by at least two times the amplitude of the first and second signals every two-stage;

the signal terminals of the odd numbered units starting from the third unit are connected to clock signals which have the same phase as the first signal with a HIGH level of the clock signal voltages starting from at least three times the amplitude of the first and second signal; and thereafter the HIGH level of the clock signal increasing progressively along the chain by at least two times the amplitude of the first and second signals every two-stage, and

the output terminal of the last unit of the chain is the output terminal of the chain, wherein;

the CMOS transistors are PMOS transistors.

In the fifth aspect, the invention provides a charge transfer chain for generating an output voltage in response to

an input voltage, a first chain signal, a second chain signal and a plurality of clock signals, such that the output voltage has a greater magnitude than the input voltage, said charge transfer chain comprising

a plurality of serially connected charge transfer units according to claim 1, such that:

the input terminal of the first unit is connected to the input voltage and the input terminal of subsequent units are connected to the output terminal of its preceding unit;

the signal terminal of the first unit is connected to the first signal;

the clock terminals of the odd numbered units starting from the first unit are connected to the first signal;

the clock terminals of the even numbered units starting from the second unit are connected to the second signal;

the clock terminal of the last unit is connected to a voltage potential, such as ground;

the signal terminals of the even numbered units starting from the second unit are connected to clock signals which have the same phase as the second signal with a LOW level of the clock signal voltages starting from a negative voltage of at most one time the amplitude of the first and second signal; and thereafter the LOW level of the clock signal decreasing progressively along the chain by at least two times the amplitude of the first and second signals every two-stage;

the signal terminals of the odd numbered units starting from the third unit are connected to clock signals which have the same phase as the first signal with a LOW level of the clock signal voltages starting from a negative voltage of at most two times the amplitude of the first and second signal; and thereafter the LOW level of the clock signal decreasing progressively along the chain by at least two times the amplitude of the first and second signals every two-stage, and

the output terminal of the last unit of the chain is the output terminal of the chain, wherein;

the CMOS transistors are NMOS transistors.

In the sixth aspect, this invention provides a charge pump for generating an output voltage in response to

an input voltage, a first signal, a second signal, such that the output voltage has a greater magnitude than the input voltage; comprising

two charge transfer chains according to claim 4 or 5, wherein

the signal terminal of the first unit of the first chain is connected to the first signal;

the signal terminal of the first unit of the second chain is connected to the second signal;

the input terminals of the first units in both chains are connected to the input voltage;

the clock terminals of the odd numbered units of the first chain starting from the first unit are connected to the first signal;

the clock terminals of the even numbered units of the first chain starting from the second unit are connected to the second signal;

the clock terminals of the odd numbered units of the second chain starting from the first unit are connected to the second signal;

the clock terminals of the even numbered units of the second chain starting from the second unit are connected to the first signal;

the signal terminal of each unit of the first chain starting from the second unit is connected to the input terminal of the corresponding unit in the second chain;

the signal terminal of each unit of the second chain starting from the second unit is connected to the input terminal of the corresponding unit in the first chain;

the clock terminals of the last unit of both chains are connected to voltage potentials, such as ground, and

the output terminals of the chains correspond to output terminals of the charge pump.

With reference to the charge pump according to the present invention, this demonstrates a reduced loss as compared to the prior art due to the threshold drop in the charge pump voltage gain. The circuit according to the present invention presented may include either a PMOS or NMOS transistor based switch.

Further, the charge pump of the present invention does not produce an output voltage that is higher than the desired output voltage and so does not require high breakdown voltage transistors, which have a negative impact on the manufacturing processes and, subsequently, cost. A charge pump according to the present invention is able to operate over a wider range of voltage input. Further, the current charge pump design may be easier to implement in design and layout because the charge pump can be divided into unit structures.

It is understood that a switch formed by a CMOS transistor can be replaced by two or more transistors configured as switches connected in a serial or parallel manner. Further, and in this case, the first switch may be implemented without the switching well mechanism. Whilst falling within the invention, this is less preferred as the switch may suffer from body effect and result in a higher loss as compared to alternative arrangements of the invention, such as the above preferred embodiment. There may also be potential latch-up problem if the well of the transistor is not biased to the proper potential.

### BRIEF DESCRIPTION OF THE DRAWINGS

It will be convenient to further describe the present invention with respect to the accompanying drawings which illustrate possible arrangements of the invention. Other arrangements of the invention are possible, and consequently the particularity of the accompanying drawings is not to be understood as superseding the generality of the preceding description of the invention.

FIG. 1 is a charge pump circuit according to the prior art including its voltage clock signal patterns;

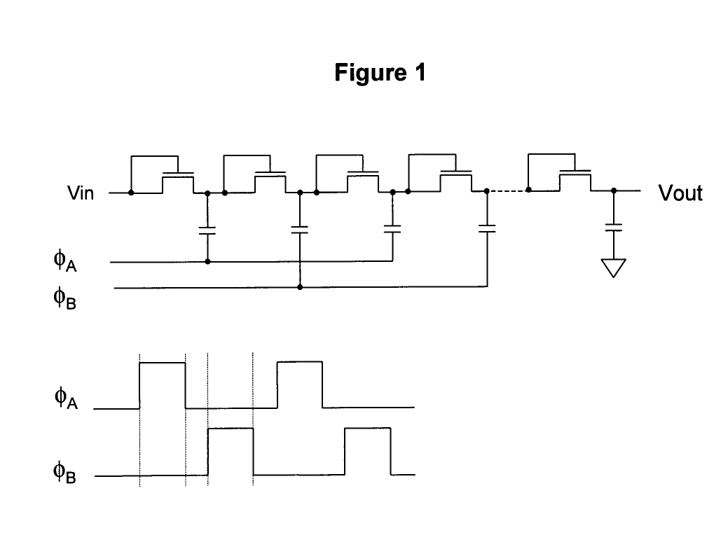

FIG. 2 is a further charge pump circuit according to the prior art;

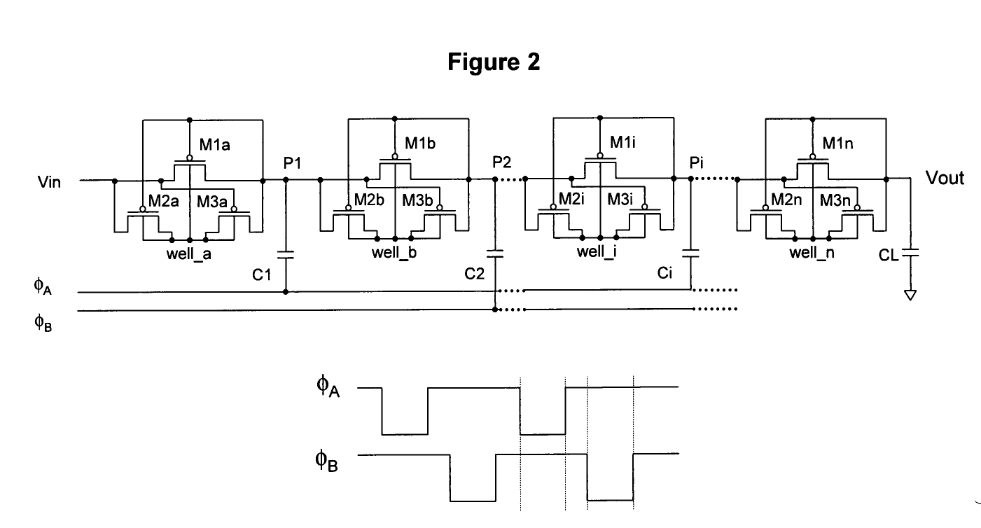

FIG. 3 is a PMOS transistor based charge pump circuit according to one embodiment of the present invention;

FIG. 4 is a graph showing voltage signals for various terminals of the charge pump of FIG. 3.

FIG. 5 is a PMOS transistor based single charge transfer chain.

FIG. 6 is a NMOS transistor based charge pump circuit according to further embodiment of the present invention.

FIG. 7 is a graph of the non-overlapping voltage clock signals supplied for the charge pump circuit of FIG. 6.

FIG. 8 is a graph providing a comparison of output voltage of the present charge pump with the prior art.

FIG. 9 is a graph providing another comparison of output voltage of the present charge pump with the prior art.

### DETAILED DESCRIPTION OF PREFERRED EMBODIMENTS

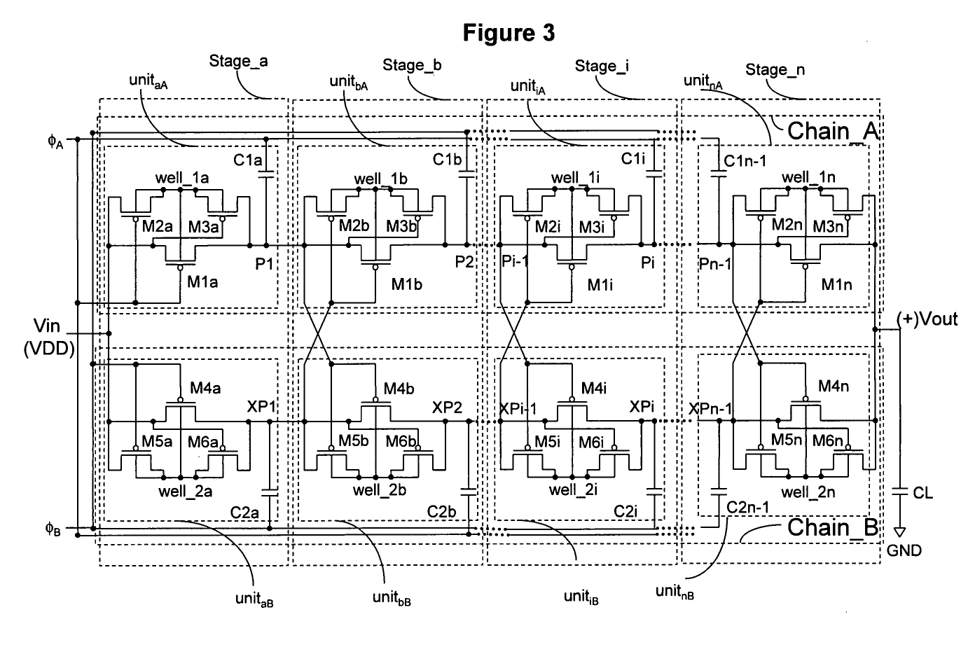

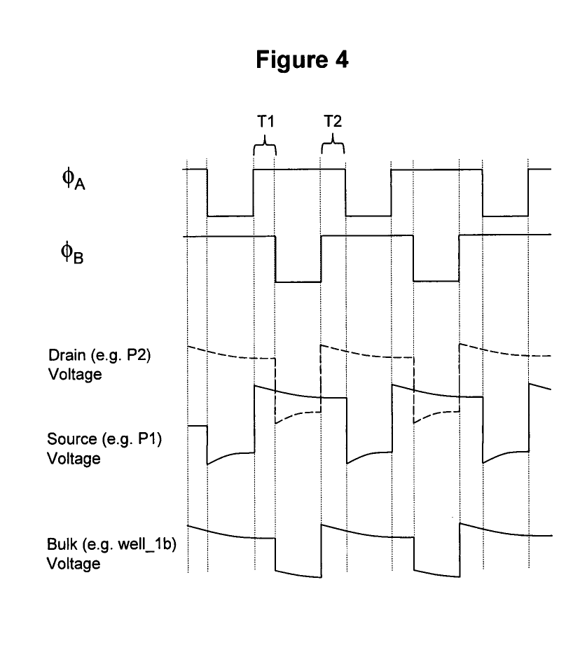

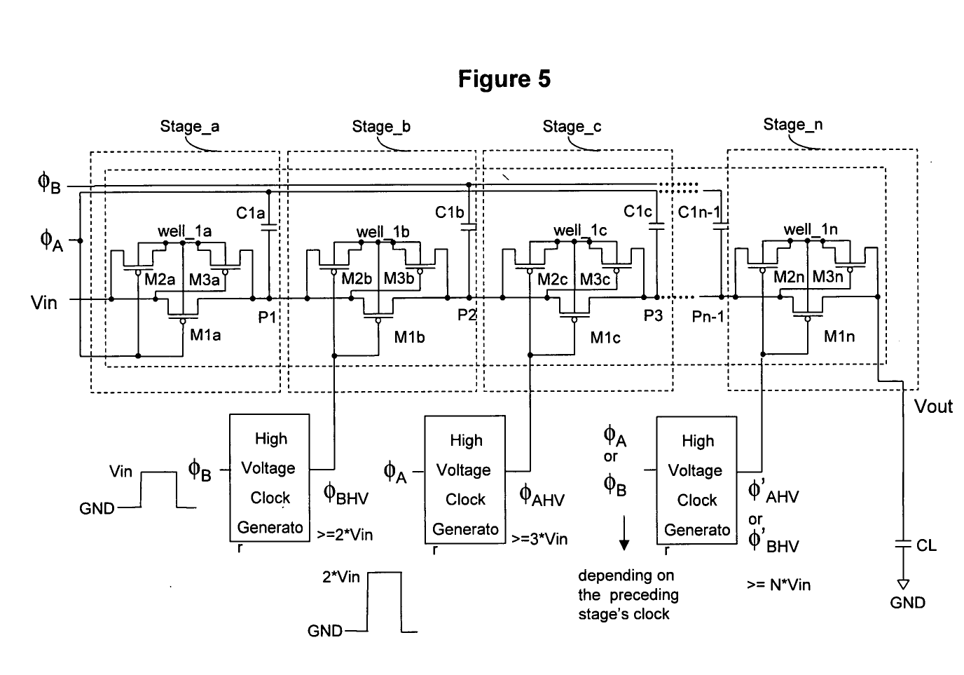

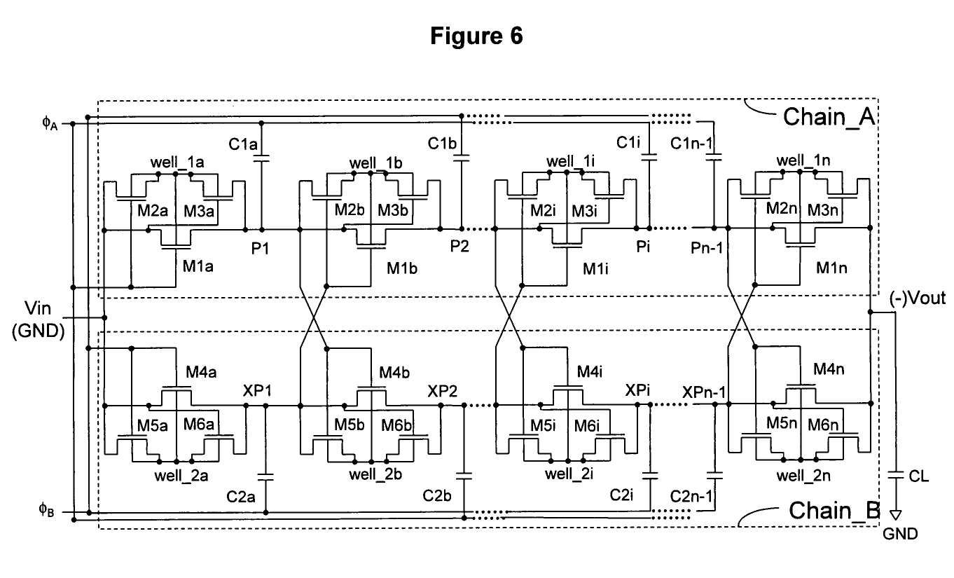

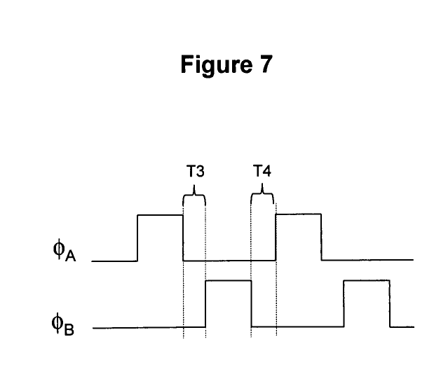

The electronic circuit diagram of the present example for a charge pump employing PMOS transistors configured as switches is shown in FIG. 3. Voltage signals for this circuit in FIG. 3 at various terminals are depicted in FIG. 4. As an example of using a plural number of charge transfer units, FIG. 5 presents a single charge transfer chain based on PMOS transistors. A further embodiment of the invention whereby the circuit uses NMOS transistors configured as switches, is shown in FIG. 6 with the voltage clock signals as presented in FIG. 7. All CMOS transistors employed according to the present invention (e.g., M1i, M2i, M3i, M4i, M5i & M6i), whether they are PMOS or NMOS transistors, are configured as switches.

The charge pump circuit according to FIG. 3 comprises charge transfer chains, chain_A and chain_B, enclosed by two separate dash-lines respectively. A plural number of charge transfer units (unit_{aA}, unit_{bA}, unit_{iA}, . . . , unit_{nA}) are serially connected to form a charge transfer chain chain_A. Similarly, a plurality of charge transfer units (unit_{aB}, unit_{bB}, . . . , unit_{iB}, . . . unit_{nB}) form the corresponding charge transfer chain chain_B. This charge pump comprises a plurality of charge transfer stages labelled as stage_a, stage_b, . . . , stage_i, . . . , stage_n with each stage also encircled by dash-lines. Any arbitrary charge transfer stage (e.g., stage_i), except the input stage stage_a, comprises two similar charge transfer units, unit_{iA} & unit_{iB}, corresponding to respective charge transfer chains, chain_A & chain_B, cross-coupled. M1i and M4i are called first switches of their respective charge transfer units; M2i and M5i are termed as second switches of their respective charge transfer units; M3i and M6i are referred as third switches of their respective charge transfer units. For clarity, the left-hand side terminal of a CMOS transistor is termed as source and the right-hand side terminal is termed as drain for all accompanying figures.

In FIG. 3, at the input stage (stage_a), each of the charge transfer units (unit_{aA} & unit_{aB}) has three terminals, which are the input (Vin), signal/clock (φ_{A} or φ_{B}) and output (P1 or XP1) terminals. In unit_{aA}, Vin is connected to sources of CMOS transistors M1a, M2a, and gate of M3a. One of the voltage clock signals φ_{A} is connected to the output of unit (unit_{aA}) through pump capacitor C1a and also connected to the gates of M1a and M2a. In unit_{aB}, Vin is connected to sources of M4a, M5a, and gate of M6a. The other non-overlapping voltage clock signal φ_{B} is connected to the output of unit (unit_{aB}) through pump capacitor C2a and also connected to the gates of M4a and M5a. In other words, the gates of M1a & M4a are cross-coupled to the clock signals φ_{A} & φ_{B}. Signals φ_{A} & φ_{B} may be interchanged and this applies to the subsequent stages of the charge pump too. An example of clock signals φ_{A} & φ_{B} is shown in FIG. 4.

Within every intermediate charge transfer unit, for an example, unit_{iA} of chain_A, there are three PMOS transistors (M1i, M2i & M3i) configured as switches and a capacitor (C1i). The input (Pi-1) of this charge transfer unit (unit_{iA}) is given to the sources of M1i and M2i, which is also its preceding unit's output terminal (Pi-1). The output (Pi) of this charge transfer unit (unit_{iA}) is given by the drains of M1i and M3i. The clock terminal for this charge transfer unit is given by one of the terminals of the capacitor. For the sake of regularity, the input and output stages of a charge pump follow the same convention in the terminal labelling. In addition, the source of M1i is connected to the gate of M3i. All three PMOS transistors (M1i, M2i & M3i) sit in the same well (labelled as well_1i). The drain of M2i & source of M3i are connected to well_1i too. A capacitor C1i is connected to output terminal Pi. The capacitors (e.g., C1i & C2i) in the charge transfer units can also be formed by CMOS transistors. Here, the width of transistors M2i & M3i are preferably not larger than that of M1i. Preferably, the width of M2i and M3i transistors of a charge transfer unit (unit_{iA} or unit_{iB}) may be the same. It is also possible that the width of M2i or M3i may be as small as 5% of the width of M1i transistor. The charge transfer units therefore achieve the function of giving an output voltage, which is one VDD higher than its input with the help of voltage clock signal, either φ_{A} or φ_{B}, if Vin and the amplitude of clock signals φ_{A}, φ_{B} are the same as VDD.

The charge transfer unit (unit_{iB}) from the opposite/respective charge transfer chain chain_B has almost the same configuration. For an example, all three transistors (M4i, M5i & M6i) sit in the same well (labelled as well_2i) while the sources of M4i & M5i are linked together to the input XPi-1. The drains of M4i & M6i are linked together to an output XPi while the capacitor C2i connects the drains of M4i & M6i to another clock signal, either φ_{A} or φ_{B} Preferably, the width of M5i and M6i transistors of the charge transfer unit unit_{iB} may be the same or no larger than the width of M4i's, and may be as small as 5% of the width of M4i transistor.

Between two respective interchangeable charge transfer units (e.g., unit_{iA} & unit_{iB}) from respective charge transfer chains, such as chain_A and chain_B, the gates of M1i & M2i from chain_A are connected to sources of M4i & M5i. On the other hand, the gates of M4i & M5i are connected to the sources of M1i and M2i. In another word, the corresponding charge transfer units (unit_{iA} & unit_{iB}) from respective chains are cross-coupled to form a charge transfer stage (stage_i). Therefore, the gates of the charge transfer devices, e.g., M1i & M2i, in one chain, e.g., chain_A, are biased by the output node of a preceding stage in another chain, e.g., chain_B, and vice versa. For an example, the gate of M1b in chain_A is driven by the output XP1 of the first stage in chain_B.

At the output stage stage_n (see FIG. 3), the output of chain_A & chain_B, which is the drains of M1n, M3n, M4n and M6n, is connected to a load capacitor CL. Taking output from each charge transfer chain separately by connecting each chain to the ground via a capacitor separately is another possible arrangement, in which two charge pump outputs are made available.

During operation of a charge transfer unit according to FIGS. 3 & 4, when the first CMOS transistor (M1i) is on, the second CMOS transistor (M2i) is always turned on. Then the source and body of the first CMOS transistor are connected through the second CMOS transistor so that no reverse bias exists between the source and body of the first CMOS transistor, thus preventing threshold voltage increase. When the first CMOS transistor is off, the third CMOS transistor (M3i) is always turned on so that the drain and body of the first CMOS transistor are connected to prevent the body from floating.

During operation of a charge pump according to FIGS. 3 & 4, when φ_{A} is at LOW and φ_{B} is at HIGH, M1a and M2a are turned on, M3a is turned off and the bulk of M1a is connected to its source terminal. M4a and M5a are turned off, M6a is turned on and the bulk of M4a is connected to its drain. Then, the node P1 is charged to Vin by the input voltage. On the next clock phase, φ_{A} is at HIGH and φ_{B} is at LOW, M1a and M2a are turned off, M3a is turned on and the bulk of M1a is connected to its drain. M4a and M5a are turned on, M6a is turned off and the bulk of M4a is connected to its source. Then, the voltage at node P1 is elevated from Vin to 2*Vin, and node XP1 is charged to Vin by the input voltage (if the amplitude of clocks φ_{A} and φ_{B} are the same as Vin) as M4a is turned on now. Since XP1 drives the gate of M1b, M1b is turned on and the charge from node P1 is transferred to node P2 which brings the voltage at node P2 to 2*Vin. On the next clock phase, when φ_{A} is at LOW and φ_{B} is at HIGH again, the voltage at node P2 is elevated to 3*Vin.

This charge transfer mechanism repeats in the subsequent stages and charges are eventually built up at the output of each stage.

Neglecting charge transfer losses, the final output voltage Vout may be N*Vin, where N is the number of stages including the output stage. The losses are due to the presence of parasitic capacitance at each output nodes and the output current loading. Considering these losses, the final output voltage Vout may be approximated by the following equation:

$$Vout = N \times Vin \times ( \frac{{C}_{pump}}{{C}_{pump} + {C}_{para}} ) - \frac{{I}_{load}}{[ f \times ( {C}_{pump} + {C}_{para} ) ]} \qquad ( 2 )$$

where Cₚᵤₘₚ is the pump capacitance at each stage, Cₚₐᵣₐ is the total parasitic capacitance at each stage, I_{load} is the output load current, and f stands for the frequency of the voltage clock signals φ_{A} and φ_{B}

To reduce these losses, there are three possible ways. Firstly, the clock frequency may be increased. Secondly, the capacitance of Cₚᵤₘₚ may be increased to make the parasitic capacitance Cₚₐᵣₐ insignificant. Thirdly, the size/width of transistors may be optimised to trade-off the transistor's parasitic capacitance and the on-resistance of the transistor.

The non-overlapping LOW clock signals in FIG. 4 are used to drive Cₚᵤₘₚ in the charge pump circuit. It is preferred that the duration of voltage signal HIGH is longer than LOW for the PMOS transistor based design. Besides, the duration of HIGH voltage signal preceding LOW is preferred to be almost equal to the duration following LOW signal. In another word as shown in FIG. 4, the non-overlapping portions of clock signals φ_{A} and φ_{B}, indicated as T1 and T2, are ideally preferred to have the same time duration (T1=T2) although they may not be of the same duration over every cycle in practical situations. The rise time and the fall time of the two non-overlapping clocks are also preferred to be the same although this is not necessary to be strictly followed in practical situations too. It is possible that non-overlapping HIGH clock signals be used, but this will cause losses in the operation, which lowers the charge pump efficiency.

Finally, the charge pump according to the present example works well to a supply voltage as low as one-threshold voltage of a MOSFET transistor. In an ideal situation, there is no upper limit of the supply voltage for the circuit to operate well. However, the voltage limit is practically set by the process breakdown voltage of the MOSFETs.

During operation, each output node (P1, . . . , Pn-1, XP1, . . . , XPn-1 and Vout) may be discharged to the ground if the application of charge pump requires the same Vout rise time on every start-up operation. In one example, the discharge may be implemented by using a NMOS transistor configured as a switch. The discharge cycle may not be needed if the Vout rise time can be controlled by external circuitry.

A plurality of serially connected charge transfer units (e.g., unite) form a charge transfer chain as shown in FIG. 5. Here, a single chain of the charge transfer units is implemented using PMOS transistors. The first input unit of a single chain has the same configuration as the input unit of either one of the cross-coupled chains. Since there is no second chain to provide the gate biases of the main charge transfer switches M1b, . . . , M1n, additional circuits to drive these gates are necessary. These circuits could be in the form of high voltage clock generators as shown in FIG. 5.

In FIG. 5, every stage of this charge transfer chain, except the first stage, has its own high voltage clock generator to bias the gates of the transistors M1b, . . . , M1n. Each of the high voltage clock generators takes as its input the clock signal that is driving the pump capacitor of that stage, and produces an output clock signal that is in phase with this input clock signal. The output clock signal of each clock generator has a HIGH level that is at least the same as the HIGH level of the voltage at nodes P1, . . . , Pn-1 respectively. As the voltage at nodes P1, . . . , Pn-1 builds up along the chain, the HIGH level of the output clock signal of the respective clock generator should thus be progressively escalated.

A charge transfer chain as shown in FIG. 5 is also able to present a voltage output with a greater magnitude than its input. Consider FIG. 3 again which is the cross-coupled double chain design. In stage_b, the gate of M1b is driven by the node XP1, which oscillates between Vin and 2*Vin depending on the clock phases. One end of the pump capacitor C1b is connected to the clock signal φ_{B}.

In order for the single charge transfer chain shown in FIG. 5 to function as desired, as an example, the high voltage clock generator of stage_b should produce an output clock φ_{BHV} which is in phase with clock φ_{B}, and has a HIGH level of at least 2*Vin. The LOW level of this output clock φ_{BHV} can be Vin or ground/GND as long as the amplitude is at least equal to Vin.

In the embodiment shown in FIG. 5, stage_b comprises of M1b, M2b, M3b, and C1b, with one end of C1b connected to clock signal φ_{B}. To drive the gate of M1b, a high voltage clock generator is required and its input is connected to clock φ_{B}. The output clock φ_{BHV} of this high voltage clock generator has a HIGH level of at least 2*Vin, and is in phase with clock φ_{B} The LOW level of the output clock φ_{BHV} can be Vin or GND, as long as the amplitude is at least equal to Vin. The high voltage clock generator design can be in the form of a conventional level shifter circuit, or any other circuit that performs the intended function. Similarly, as the chain is progressively built with charge transfer units in serial connections, the driving voltage for the gates of those CMOS transistors (e.g., M1c, M1d, . . . , M1n) require high voltage clocks with a HIGH level of at least 1*Vin more per stage, with alternating clock phases.

Alternatively, a charge transfer chain may also use only NMOS transistors. However, the clock signals from the high voltage clock generators are negative pulses with a LOW level starting from a negative voltage of at most one time the amplitude of φ_{A} and φ_{B}, and thereafter decreasing progressively along the chain by at least one time the amplitude of φ_{A} and φ_{B}.

As another example, FIG. 6 shows an alternative embodiment of the invention using NMOS transistors with the clock signals φ_{A} & φ_{B} as shown in FIG. 7. The clock signals φ_{A} & φ_{B} are preferred to be non-overlapping HIGH. The input voltage in this embodiment may be connected to the ground. This embodiment uses only NMOS transistors in contrast with the embodiment in FIG. 3 using only PMOS transistors. The Vout generated in this embodiment ideally may give a negative high voltage of (N−1)*Vin.

Considering the losses, the magnitude of the negative voltage output is expressed as follows:

$$Vout = ( N - 1 ) \times Vin \times ( \frac{{C}_{pump}}{{C}_{pump} + {C}_{para}} ) - \frac{{I}_{load}}{[ f \times ( {C}_{pump} + {C}_{para} ) ]} \qquad ( 3 )$$

Similarly, in FIG. 7, the non-overlapping portions of clock signals φ_{A} and φ_{B}, indicated as T3 and T4, are ideally preferred to have the same duration (T3=T4). For the same reason of having T1=T2, the configuration of T3=T4 makes the charge pump more robust against the shift in the wafer fabrication process parameters.

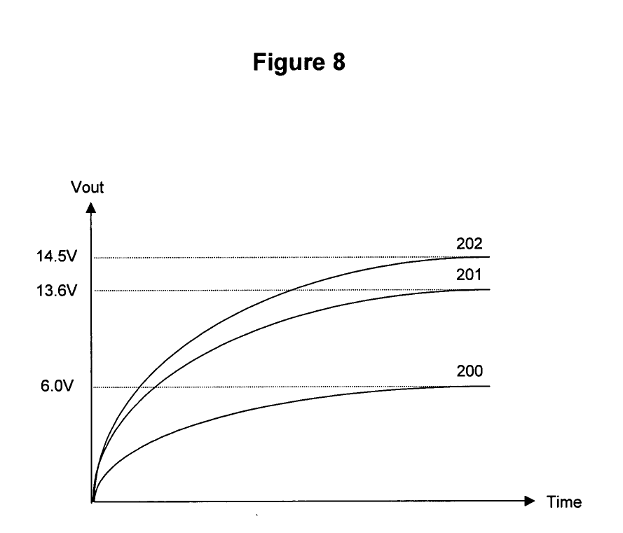

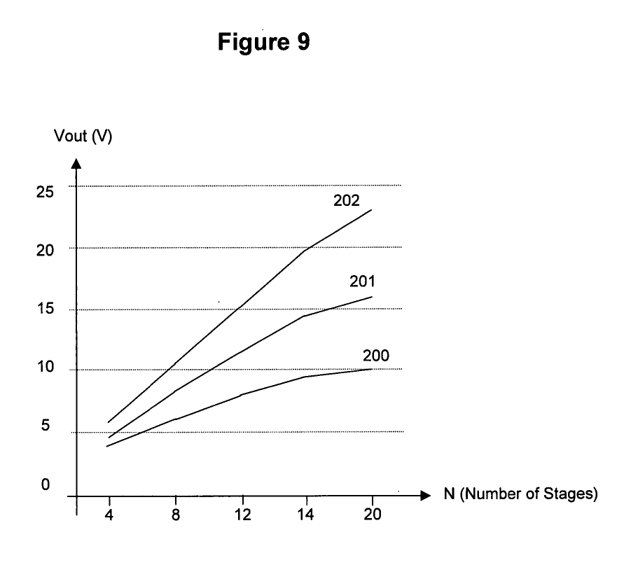

The comparison of voltage output efficiency for various charge pumps is depicted in FIGS. 8 and 9. In FIG. 8, the output voltages of various charge pumps are given, where the input supply voltage and the amplitude of φ_{A} & φ_{B} are 2.2V, the number of stages of each type of charge pump is 10 and the process distribution falls in the typical corner. Here, the curve 200 represents the performance of Dickson charge pump, curve 201 represents the performance of Shin et al's charge pump, and curve 202 represents the performance of the charge pump according to the present invention. The charge pump according to the present invention has an output which is 242% of the output voltage of a Dickson charge pump. FIG. 9 shows the comparison of the output voltage of each type of charge pump for different number of stages, where the input supply voltage is kept at 1.8V and the process distribution falls in the typical corner. Here, curve 200 represents the performance of Dickson charge pump, curve 201 represents the performance of Shin et al's charge pump, and curve 202 represents the performance of the charge pump according to the present invention. The output voltage of the charge pump according to the present invention has an output voltage which is 230% of the output voltage of a Dickson charge pump.

1. A charge transfer unit for generating an output voltage in response to an input voltage, a first unit signal, and a second unit signal, such that the output voltage has a greater magnitude than the input voltage; said charge transfer unit comprising:
a first, a second and a third CMOS transistors and a capacitor;
an input terminal, in communication with sources of the first and second transistors and a gate of the third transistor, said input terminal connected to the input voltage;
a signal terminal, in communication with gates of the first and second transistors, said signal terminal connected to the first unit signal;
an output terminal, in communication with drains of the first and third transistors and a first terminal of the capacitor, said output terminal connected to the output voltage;
a clock terminal, in communication with second terminal of the capacitor, said clock terminal connected to the second unit signal, and; bulks of the three CMOS transistors connected to the drain of the second CMOS transistor and the source of the third CMOS transistor; wherein
the CMOS transistors are configured as switches.

2. A charge transfer input stage for generating an output voltage in response to at least one input voltage, a first stage signal and a second stage signal; said charge transfer input stage comprising two charge transfer units according to claim 1, wherein
the clock and signal terminals of the first charge transfer unit are connected to the first stage signal, and;
the clock and signal terminals of the second charge transfer unit are connected to the second stage signal, wherein
the input terminals of each unit are connected to either different or the same input voltage.

3. A charge transfer stage for generating an output voltage in response to two input voltages, a first stage signal and a second stage signal, said charge transfer stage comprising two charge transfer units according to claim 1, wherein
the clock terminal of the first unit is connected to the first signal;
the clock terminal of the second unit is connected to the second signal;
the input terminals are connected to different input voltages;
the signal terminal of the first unit is connected to the input terminal of the second unit, and
the signal terminal of the second unit is connected to the input terminal of the first unit.

4. A charge transfer chain for generating an output voltage in response to an input voltage, a first chain signal, a second chain signal and a plurality of clock signals, such that the output voltage has a greater magnitude than the input voltage, said charge transfer chain comprising
a plurality of serially connected charge transfer units according to claim 1, such that:
the input terminal of the first unit is connected to the input voltage and
the input terminal of subsequent units are connected to the output terminal of its preceding unit;
the signal terminal of the first unit is connected to the first signal;
the clock terminals of the odd numbered units starting from the first unit are connected to the first signal;
the clock terminals of the even numbered units starting from the second unit are connected to the second signal;
the clock terminal of the last unit is connected to a voltage potential, such as ground;
the signal terminals of the even numbered units starting from the second unit are connected to clock signals which have the same phase as the second signal with a HIGH level of the clock signal voltages starting from at least two times the amplitude of the first and second signal; and thereafter the HIGH level of the clock signal increasing progressively along the chain by at least two times the amplitude of the first and second signals every two-stage;
the signal terminals of the odd numbered units starting from the third unit are connected to clock signals which have the same phase as the first signal with a HIGH level of the clock signal voltages starting from at least three times the amplitude of the first and second signal; and thereafter the HIGH level of the clock signal increasing progressively along the chain by at least two times the amplitude of the first and second signals every two-stage, and
the output terminal of the last unit of the chain is the output terminal of the chain, wherein;
the CMOS transistors are PMOS transistors.

5. A charge transfer chain for generating an output voltage in response to an input voltage, a first chain signal, a second chain signal and a plurality of clock signals, such that the output voltage has a greater magnitude than the input voltage, said charge transfer chain comprising
a plurality of serially connected charge transfer units according to claim 1, such that:
the input terminal of the first unit is connected to the input voltage and the input terminal of subsequent units are connected to the output terminal of its preceding unit;
the signal terminal of the first unit is connected to the first signal;
the clock terminals of the odd numbered units starting from the first unit are connected to the first signal;
the clock terminals of the even numbered units starting from the second unit are connected to the second signal;
the clock terminal of the last unit is connected to a voltage potential, such as ground;
the signal terminals of the even numbered units starting from the second unit are connected to clock signals which have the same phase as the second signal with a LOW level of the clock signal voltages starting from a negative voltage of at most one time the amplitude of the first and second signal; and thereafter the LOW level of the clock signal decreasing progressively along the chain by at least two times the amplitude of the first and second signals every two-stage;
the signal terminals of the odd numbered units starting from the third unit are connected to clock signals which have the same phase as the first signal with a LOW level of the clock signal voltages starting from a negative voltage of at most two times the amplitude of the first and second signal; and thereafter the LOW level of the clock signal decreasing progressively along the chain by at least two times the amplitude of the first and second signals every two-stage, and
the output terminal of the last unit of the chain is the output terminal of the chain, wherein;
the CMOS transistors are NMOS transistors.

6. A charge pump for generating an output voltage in response to an input voltage, a first signal, a second signal, such that the output voltage has a greater magnitude than the input voltage; comprising
two charge transfer chains according to claim 4, wherein
the signal terminal of the first unit of the first chain is connected to the first signal;
the signal terminal of the first unit of the second chain is connected to the second signal;
the input terminals of the first units in both chains are connected to the input voltage;
the clock terminals of the odd numbered units of the first chain starting from the first unit are connected to the first signal;
the clock terminals of the even numbered units of the first chain starting from the second unit are connected to the second signal;
the clock terminals of the odd numbered units of the second chain starting from the first unit are connected to the second signal;
the clock terminals of the even numbered units of the second chain starting from the second unit are connected to the first signal;
the signal terminal of each unit of the first chain starting from the second unit is connected to the input terminal of the corresponding unit in the second chain;
the signal terminal of each unit of the second chain starting from the second unit is connected to the input terminal of the corresponding unit in the first chain;
the clock terminals of the last unit of both chains are connected to voltage potentials, such as ground, and
the output terminals of the chains correspond to output terminals of the charge pump.

7. The charge transfer stage according to claim 3, wherein both clock terminals are connected together to a voltage potential, such as ground, and both output terminals are connected together to form a single output terminal.

8. The charge transfer chain according to claim 4, wherein the minimum amplitude of the clock signals is equal to at least the amplitude of the first and second signals.

9. The charge pump according to claim 6, wherein the output terminals of the chains are connected to form a single-ended output terminal of the charge pump.

10. The charge transfer unit according to claim 1, wherein the first and second unit signals are voltage clock signals.

11. The charge transfer unit according to claim 1, wherein the first and second unit signals are inter-changeable.

12. The charge transfer unit according to claim 10, wherein the first and second unit signals are non-overlapping.

13. The charge transfer chain according to claim 4, wherein the clock signals have two different phases.

14. The charge transfer chain according to claim 13, wherein the two different phase clock signals are non-overlapping.

15. The charge transfer chain according to claim 4, wherein the first and second signals are inter-changeable if the first phase of the clock signal is interchanged with the second phase of the clock signal and vice versa.

16. The charge transfer unit according to claim 1, wherein the CMOS transistors are PMOS transistors.

17. The charge transfer unit according to claim 1, wherein the CMOS transistors are NMOS transistors.

18. The charge transfer chain according to claim 13, wherein the non-overlapping portions of two voltage signals have the same time duration.

19. The charge transfer chain according to claim 15, wherein the non-overlapping portions of two voltage signals have the same time duration.

20. The charge transfer unit according to claim 1, wherein the width of the second or third CMOS transistor is at least 5% of the first CMOS transistor.
